(19) United States
(12) Patent Application Publication
(10) Pub. No.: US 2008/0071741 A1
(43) Pub. Date: Mar. 20, 2008

(54) Method and an apparatus to perform feature weighted search and recommendation

(76) Inventors: Kazunari Omi, Osaka (JP); Ian S. Wilson, Yokohama (JP); Arka N. Roy, Tokyo (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/523,880

(22) Filed: Sep. 19, 2006

(51) Int. Cl. G06F 17/30

(52) U.S. Cl. 707/3

(57) ABSTRACT

A method and an apparatus to perform feature weighted data search and recommendation are presented. A process for search and recommendation is driven by agents with features. The process may determine a recommended set of items out of a population of items based on a single sample item or on a sample set of items. The process starts by performing an analysis on a single item or on a set of items. A new set of agents is created by adapting existing agents based on the results of an analysis. A search and recommendation among the population of items is guided by an agent. An agent is adapted according to user feedback. A new agent is created based on a combination of several adapted agents to include the best features of each. Newly created agents are employed to determine recommendations from a population of items by comparing a similarity between an item and an agent. The recommendations are presented to a user through a user interface. The search and recommendation process continues after receiving user feedback in response to the recommendations.

### TECHNICAL FIELD

The present invention relates to computerized searching techniques, and more particularly, to feature weighted search and recommendation.

### BACKGROUND

Recommendation services or search engines are becoming more and more popular and useful in everyday life. Users often find it convenient to receive recommendations on items that the users may be interested in. For example, users may want to receive recommendations of items, such as books, music, movies, news, places, restaurants, etc., that are similar to those of the users' own taste or preferences or to those the users have found interesting. In this document, an item refers to person, place, thing, idea, etc. which may be specified separately in a group of items that could be enumerated in a list. An item is defined by a number of characteristics or traits, which are referred to as features in the following discussion.

Various recommendation services and/or search engines are available over the Internet to help users find items. Most conventional recommendation services generally rely on a comparison of a user's activity or past behaviors with that of other customers. Others rely on editor recommendations.

Some recommendation services use automatic recommendation engines, but generally such services track and evaluate one key feature of the items. These engines select a subset of the items to recommend to a user based on how well the single feature of the items matches the corresponding feature of an item which the user has indicated to be interesting. For example, a restaurant recommendation service may recommend to a user restaurants specializing in the same type of cuisine as a restaurant visited by the user. A movie recommendation service may recommend to a user a thriller movie if the user has recently rented another thriller movie.

In addition, conventional recommendation service and/or search engines explore a population of data items that are grouped according to feature similarity by gradually increasing the scope of search, one step at a time, based on the sample data set supplied by a user. This could become time consuming without the capability of varying the size of search steps. Difficulty might arise when determining a set of possible alternatives if both the size of sample set and the feature value range are small. In the following discussion, the item that the user has indicated to be interesting is referred to as a sample.

### SUMMARY

The present invention includes a method and an apparatus to perform feature weighted search and recommendation. In one embodiment, the method includes analyzing one item or a set of items selected from a population of items, creating a plurality of agents to search the population of items, and adapting a set of agents to create new agents from a plurality of existing agents. The method may further include selecting an item as a recommendation from the population based on the item's similarity to an agent.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 illustrates one embodiment of a process of search and recommendation driven by agents with features;

FIG. 2 illustrating a functional block diagram for one embodiment of driving a search and recommendation process using agents with features;

FIGS. 3A, 3B and 3C illustrate one embodiment of an initial setup for a search and recommendation process;

FIG. 4 illustrates one embodiment of an analysis of a set of sample items;

FIG. 5 illustrates one embodiment of a process for setting up an agent directly from an item;

FIG. 6 illustrates one embodiment of a process for setting up an initial agent from a set of sample items;

FIG. 7 illustrates one embodiment of a general process to perform adapting existing agents to create new agents;

FIGS. 8A and 8B illustrate one embodiment of a fitness analysis and associated formulation to calculate a zScore value to obtain a fitness score;

FIG. 9 illustrates one embodiment of a process to create new agents from existing agents after being adapted with assigned fitness scores;

FIGS. 10A and 10B illustrate one embodiment of a mating process to create a baby agent by combining a mother agent and a father agent;

FIG. 11 illustrates one embodiment of a recommending process by a set of agents to determine recommendations from a population of items; and

FIG. 12 illustrates one example of a typical computer system which may be used with the present invention.

### DETAILED DESCRIPTION

A method and an apparatus to perform feature weighted search and recommendation are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

### Details of Some Embodiments

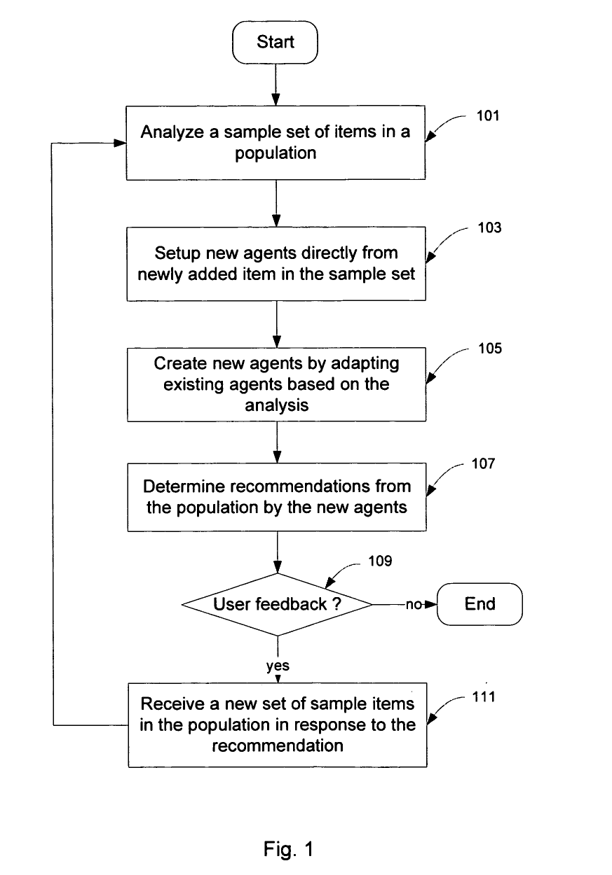

FIG. 1 is a flow diagram illustrating a process of search and recommendation driven by agents with features according to one embodiment of the invention. The process may determine a recommended set of one or more items out of a population of items based on a sample set of items. In one embodiment, a user may manually pick one item or a set of items out of the population to provide the processing logic a sample set of one or more items. In one embodiment, the sample set of one or more items may not be received from a user, but either automatically generated, or otherwise created. Each item in the sample set population may be a data with multiple features, each of which is associated with a value. A feature may correspond to a dimension. An example of three-dimensional data may be [4.5, −9, 3.3], where 4.5, −9, and 3.3 are three feature values associated with the first, second, and third dimension respectively. For example, an item may refer to a piece of music with such features including pitch, timbre, tempo, etc. Furthermore, some of the features may have different ranges. In one embodiment, the sample set may be compared to a population of items stored in a database.

Referring to FIG. 1, the process is initiated when one or more samples are received. The process may start by performing an analysis on the sample set of items 101. In one embodiment, the analysis may include calculating an average value of each L dimension over all items in the sample set. In one embodiment, the analysis may also include calculating a standard deviation of each dimension over all items in the sample set. In one embodiment, the analysis may also determine whether a received sample item is a newly added item. A sample item is newly added if the item has not appeared in any sample set nor has it been recommended by the search and recommendation process during all previous search and recommendation cycles.

Proceeding to block 103, in some embodiments, an agent may be set up directly from a newly added item from the sample set. Search and recommendation among the population of items may be guided by an agent. An agent may be, for example, a list of features with corresponding values for those features. An agent may include genes. A gene is a set of feature values associated with a set of dimensions in an agent. Each agent may have multiple genes. In one embodiment, the number of dimensions for each gene in an agent is fixed. In one embodiment, an agent may be identically structured to the items for which it makes a search and recommendation among the population of items. In one embodiment, each newly added item from the sample set corresponds to a new agent set up directly from the newly added item. In some embodiments, for each search and recommendation cycle, additional new agents are needed if the number of new agents set up directly from newly added items is smaller than a preset number.

Proceeding to block 105, additional new agents may be created by adapting existing agents based on the analysis results from block 101. An agent is adapted when changes are made with respect to its associated set of features, e.g. genes. In one embodiment, an agent may be adapted by adding new features and feature values to the list of features. In one embodiment, new features and/or values added for adapting an agent may be derived from the results of an analysis, for example, based on the average and standard deviation calculated according to a selected set of item. In one embodiment, a new agent may be created based on a combination of several agents. In one embodiment, a new agent and an adapted agent might have the same number of features and values. In one embodiment, the number of new agents is fixed for each cycle of the search and recommendation process. In some embodiments, a new agent may be set up directly from a newly added item in the sample set. An item in the sample set is newly added if the corresponding item has not appeared in any sample set nor has it been recommended by the search and recommendation process during all previous search and recommendation cycles. In one embodiment, a new agent is created for each newly added item before additional new agents are created by adapting existing agents during a search and recommendation cycle.

Proceeding to block 107, the set of new agents are employed to determine recommendations from a population of items. A recommendation may be one or more items from the population. In one embodiment, each current or new agent recommends one item. In one embodiment, an agent makes a recommendation by comparing its own features and values against each item in the population. In one embodiment, an agent recommends an item most similar to itself from the population. The recommendations may be presented to a user through a user interface. In one embodiment, the recommendations may be communicated to a separate client process operated by a user.

The search and recommendation process may be concluded or may continue depending on whether there is feedback. The process at block 109 determines whether there was user feedback in response to the recommendations at block 107. In one embodiment, a user can select a new sample set of items from the population. In one embodiment, the feedback may be generated automatically or otherwise created. An item in the recommendations may or may not be included in the feedback. If feedback is received, the search and recommendation process continues 111. At block 111 a new set of sample items is received, and the process returns to block 101 to perform an analysis of the new sample set.

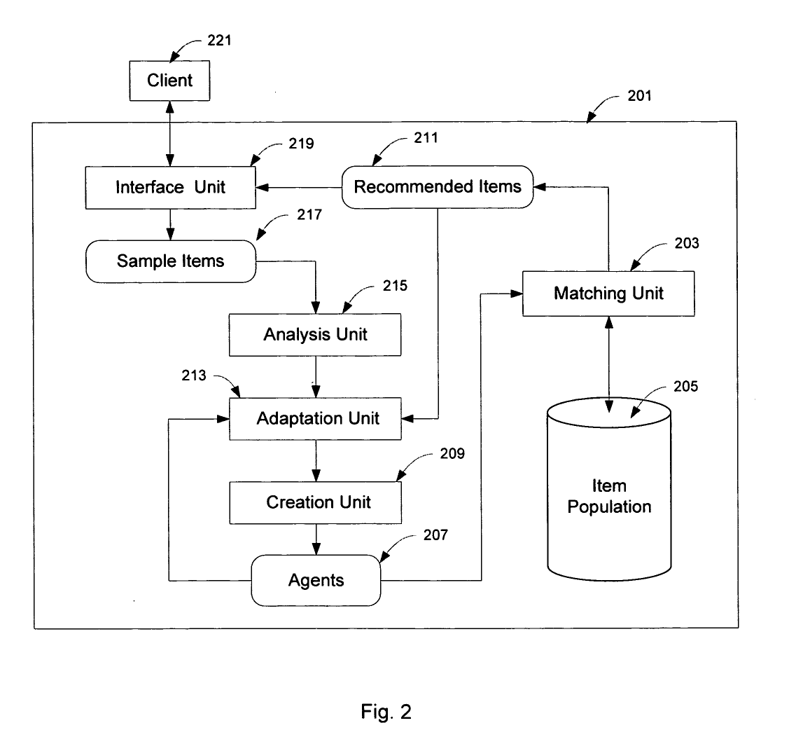

FIG. 2 is a block diagram illustrating one embodiment of architecture for driving a search and recommendation process using agents with features. Note that various software architectures may be used to implement the functions and operations described herein. The following discussion provides one example of such architecture, but it will be understood that alternative architectures may also be employed to achieve the same or similar results.

Referring to FIG. 2, according to one embodiment, system 201 includes a matching unit 203 coupled with a database or other structure storing a population of items 205 to search and recommend. The matching unit 203 compares an agent 207 with the population of items 205. In one embodiment, the matching unit 203 selects an item most similar to the agent to be one of the recommended items 211.

The adaptation unit 213 modifies agents 207 based on recommended items 211 by agents 207 and the results from an analysis unit 215. In one embodiment, each of the agents 207 has a corresponding item in recommended items 211. In one embodiment, the adaptation unit adapts each agent based on the corresponding recommended item 211.

In one embodiment, creation unit 209 generates new agents out of adapted agents received from an adaptation unit 213. In one embodiment, the creation unit 209 combines different parts of more than one adapted agent to create one new agent.

The analysis unit 215 analyzes a set of sample items 217. In one embodiment, the sample items 217 are chosen by a user. In one embodiment, the analysis unit 215 calculates several numbers for values of each feature along the sample items 217. In one embodiment, an interface unit 219 receives a set of sample items 217 from an external client 221. In one embodiment, results are also communicated via interface unit 219 to an external client 221. In one embodiment, the interface unit 219 may include a user interface. In one embodiment, the external client 221 may be a user operating a search and recommendation system 201. In one embodiment, the external client 221 may be a different process coupled with the system 201. In one embodiment, the external client 221 may be a browser on a user's computer system.

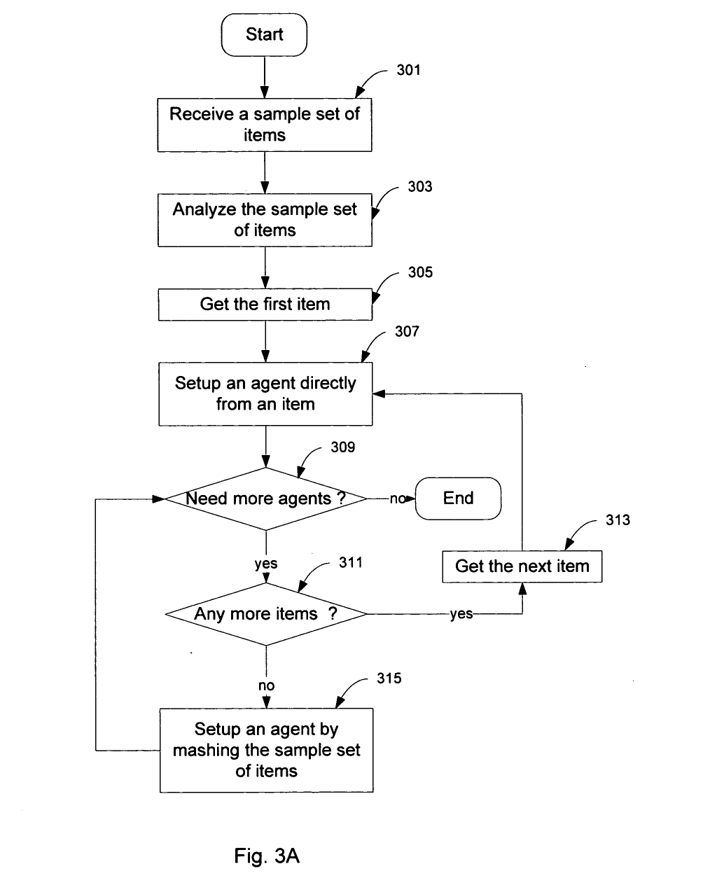

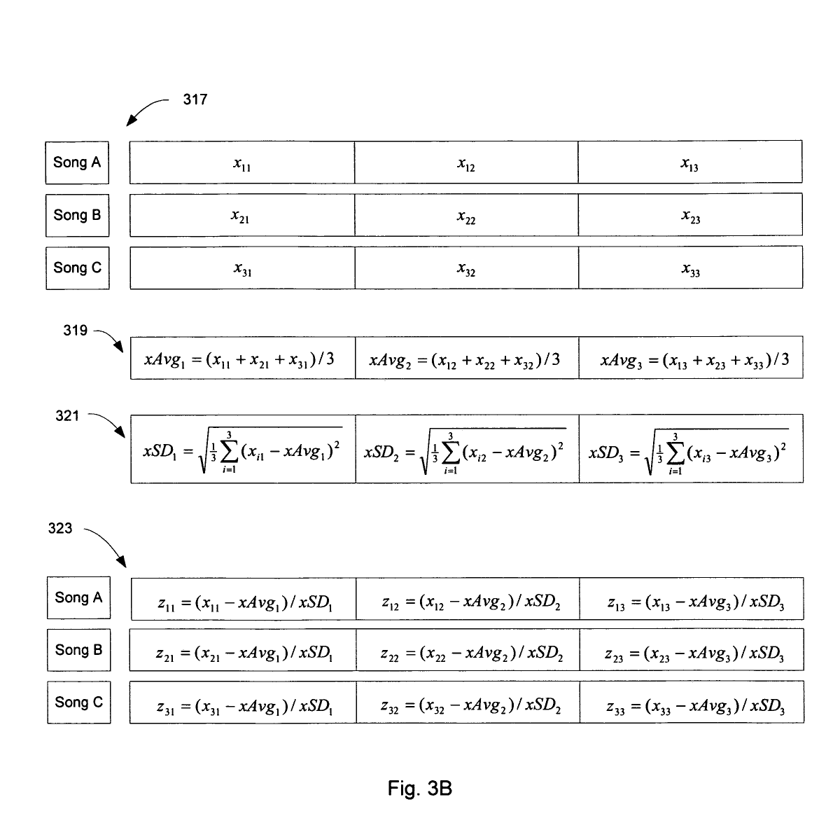

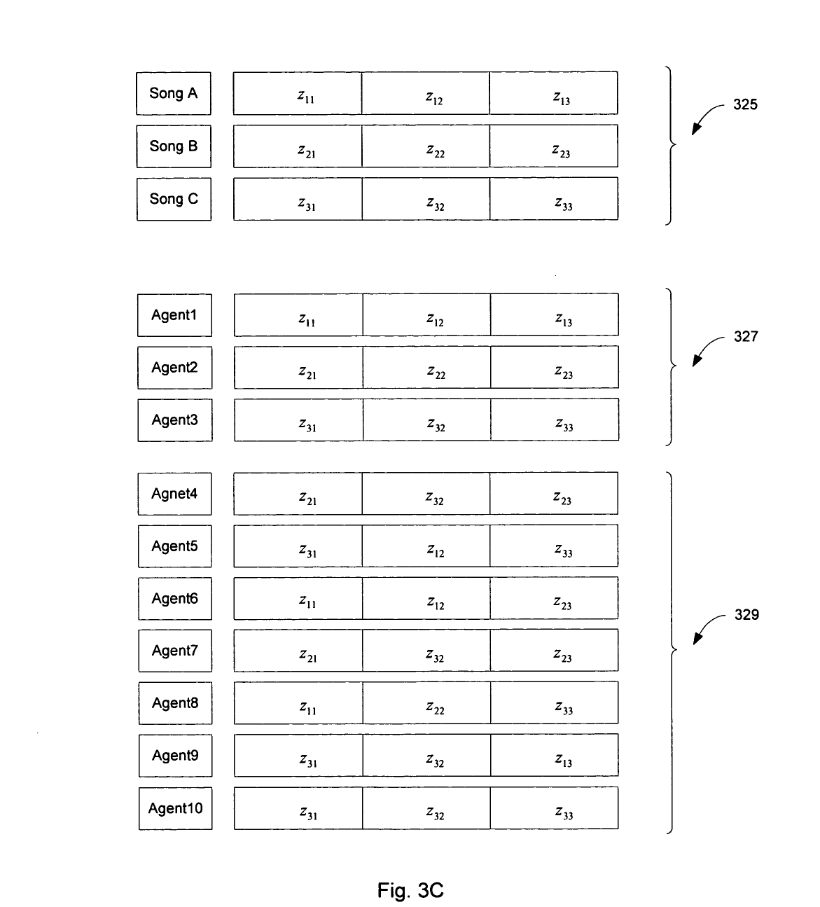

FIG. 3A is a flow diagram illustrating an initial setup for a search and recommendation process as shown in FIG. 1 according to one embodiment of the invention. In one embodiment, the search and recommendation process starts with receiving a sample set of items 301. In one embodiment, initially there are no agents present in the system implementing the search and recommendation process. In one embodiment, the sample set of items may be provided by a user operating the search and recommendation process. In one embodiment, each item has the same number of dimensions. In another embodiment, the system may insert a zero for dimensions/features which are not part of the data set of a sample item. Each dimension may correspond to a feature. In one embodiment, the system may derive the dimensions of each item in the sample set, for example, by analyzing the sample set and finding those features that are prominent in the sample set. In one embodiment, the system may derive the features for each dimension of each item in the sample set.

Proceeding to block 303, the sample set of items is analyzed. In one embodiment, the analysis derives a z-score for each feature value in the sample set of items. In one embodiment, the z-score value is a normalized feature value over all the features of the same dimension in the same set.

The process selects the first item from the sample set at block 305. An initial agent is setup directly at block 307. In one embodiment, the genes of an agent are initially assigned according to the results of the analysis 303. After setting up an agent, the process determines whether there is a need for more agents 309. In one embodiment, the determination is based on comparing the currently available set of agents against a preset number. In another embodiment, the target number of agents depends on the number of dimensions of the data set. If the total number of agents already set up meets the target number, the process ends. If the total number of agents is less than the target number, the process continues to block 311. If there are still items in the sample set that had not yet been used to generate initial agents, the next sample set item is obtained at block 313, and the process continues to block 307 to set up another agent. Otherwise, an additional initial agent is created by mashing (randomly selecting) two or more items from the sample set 315. In one embodiment, an initial agent could contain genes assigned from a plurality of sample items randomly determined.

FIGS. 3B and 3C show one example of the data generated by the process of FIG. 3A. Three sample songs, A, B and C are received from a user. These three songs are the sample set. Each has three dimensions of feature values 317. In one embodiment, these feature values are calculated by the system. In one embodiment, the system calculates an average 319 and a standard deviation 321 of feature values along each dimension over A, B and C. Subsequently, a z-score value 323 is assigned along each dimension for each song. The number of agents is preset to 10 in this example. There are only three songs in the sample set. Thus, the z-score genes of the first three initial agents 327 are setup directly from the z-scores associated with the three sample songs A, B and C 325 respectively. Each of the remaining seven initial agents 329 is assigned z-score genes by mashing the z-score values over the sample songs A, B and C along each dimension.

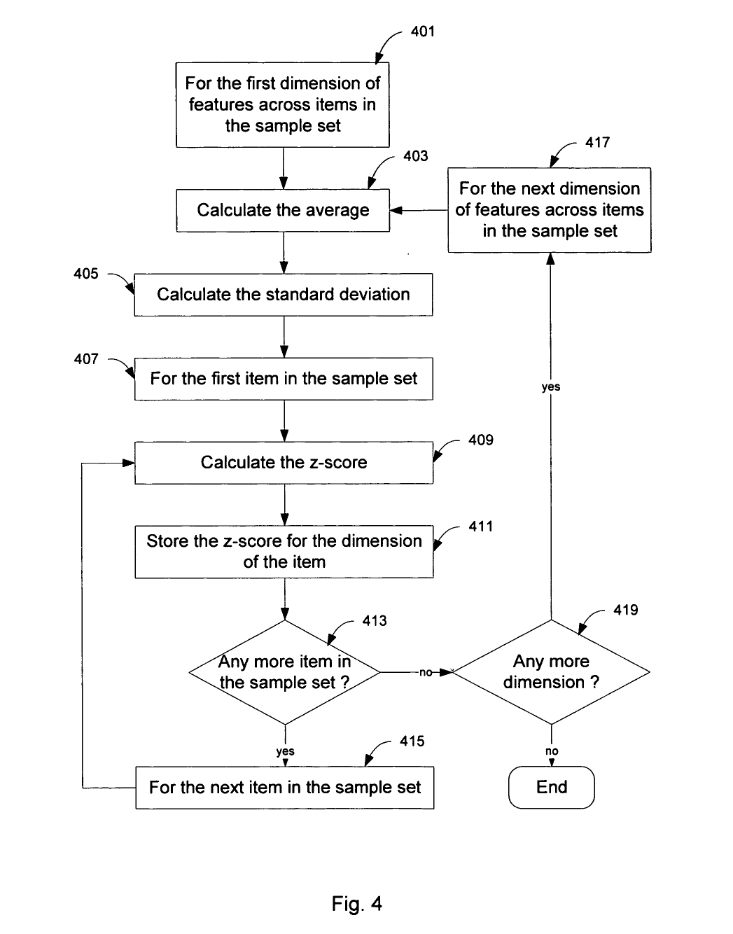

FIG. 4 is a flow diagram illustrating an analysis of a set of sample items according to one embodiment of the invention. In one embodiment, block 303 of FIG. 3A may be performed by the process shown in FIG. 4. In one embodiment, each item has the same number of dimensions, each corresponding to a feature. Referring to FIG. 4, the process starts with the first dimension of features 401 over all items in the selected set. In one embodiment, an average feature value of the same dimension across all items in the sample set is calculated 403 followed by computing a standard deviation 405 as formulated below in one example:

$${AVG}_{j} \text{:} {\tilde{x}}_{j} = \frac{1}{n} {\sum }_{i = 1}^{n} {x}_{ij}$$

$${SD}_{j} \text{:} {s}_{j} = \sqrt{\frac{1}{n} {\sum }_{i = 1}^{n} {( {x}_{ij} - {\tilde{x}}_{j} )}^{2}}$$

n: number of items
j: current dimension

### SDⱼ: standard deviation of the sample set of items along dimension j

### AVGⱼ: average of the sample set of items along dimension j

Proceeding to block 407, according to one embodiment of the invention, the analysis process converts a feature value of the current dimension to a z-score for each item in the sample set starting with the first item. A z-score is a dimensionless quantity derived by subtracting a population mean from an individual raw value and then dividing the difference by a population standard deviation. The conversion process is also known as “standardizing”. At block 409, a z-score is obtained, for example, as formulated below:

zᵢⱼ#=(xᵢⱼ−AVGⱼ)/SDⱼ

i: current item i
j: current dimension
zᵢⱼ: z-score of item i along dimension j
xᵢⱼ: raw feature value of item i along dimension j

### SDⱼ: standard deviation of the sample set of items along dimension j

### AVGⱼ: average of the sample set of items along dimension j

In one embodiment, the z-score for each feature value is stored for the corresponding item 411. Every feature value of all items in the sample set is standardized based on the z-score calculation as the analysis process loops through blocks 413, 415, 417 and 419.

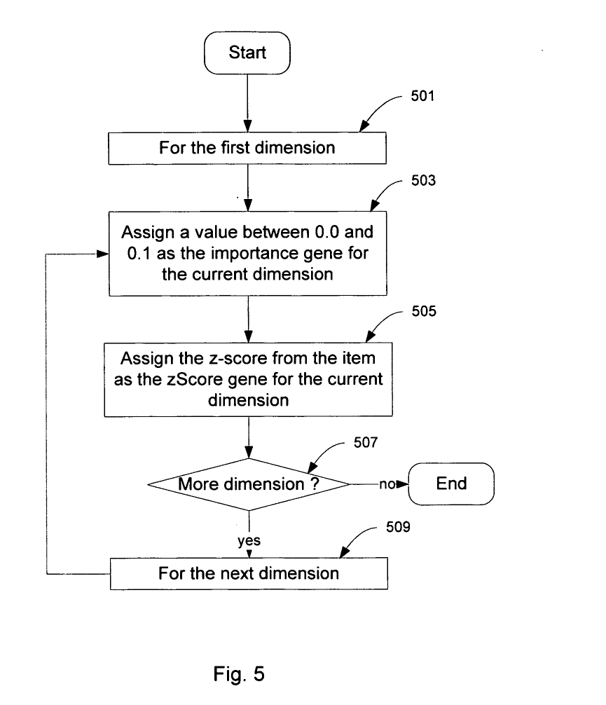

FIG. 5 is a flow diagram illustrating a process for setting up an agent directly from an item according to one embodiment of the invention. For example, block 103 in FIG. 1 and block 307 in FIG. 3A may be performed by the process in FIG. 5. Given an item, for example, the process loops through each dimension of the item 501, 507, 509, and assigns an importance gene value and a z-score gene value to an agent for each dimension. In one embodiment, the importance gene value of the current dimension for the agent is assigned as a random number between 0.0 and 1.0 503. In one embodiment, a fixed number, such as 1.0, is assigned instead of a random number. At block 505, the z-score gene value of the current dimension for the agent is assigned as the z-score of the corresponding dimension of the sample set item. The z-score may be obtained as in block 409 of FIG. 4.

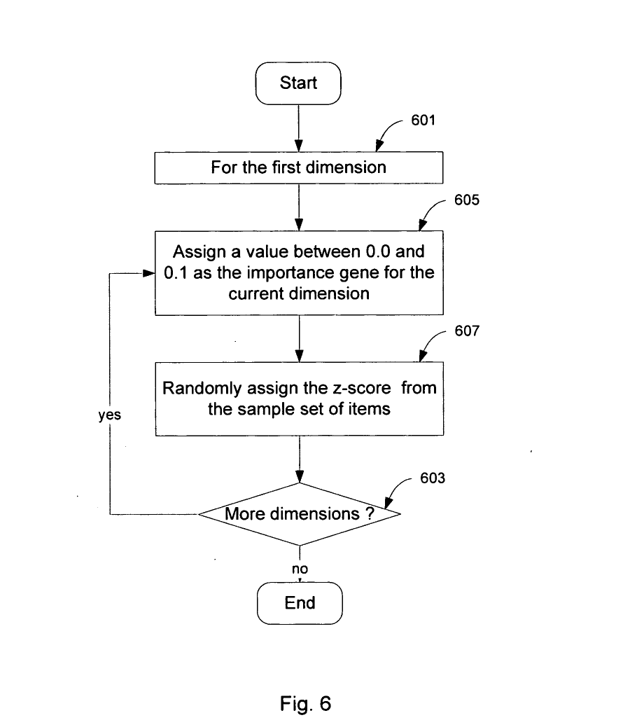

FIG. 6 is a flow diagram illustrating a process for setting up an initial agent from a set of sample items according to one embodiment of the invention. For example, block 315 in FIG. 3A may be performed by the process in FIG. 6. In one embodiment, the process in FIG. 6 loops through each dimension through blocks 601 to 603 and assigns an importance gene value and a z-score gene value for the corresponding dimension of an agent in each loop. At block 605, an importance gene value of the current dimension for the agent is assigned as a random number between 0.0 and 1.0. In one embodiment, a fixed number, such as 1.0, is assigned instead of a random number. At block 607, the z-score gene value of the current dimension for the agent is assigned as the z-score of the corresponding dimension of a randomly selected sample item from the sample set of items. The z-score may be obtained according to the process at block 409 of FIG. 4.

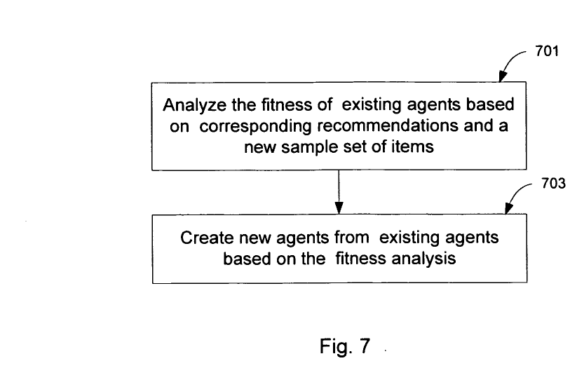

FIG. 7 is an overview flow diagram illustrating a general process to perform adapting existing agents to create new agents. FIG. 7 corresponds to block 105 in FIG. 1 according to one embodiment. Proceeding with block 701, the existing set of agents is analyzed to evaluate their fitness with respect to a sample set of items. In one embodiment, the sample set of items is received from a user of the search and recommendation system. In one embodiment, a user selects a subset of recommended items after reviewing the recommendations from the existing agents. Based on the selected subset of the recommended items, each of the agents' fitness is analyzed. Based on the results of fitness analysis at block 701, a new set of agents are created at block 703.

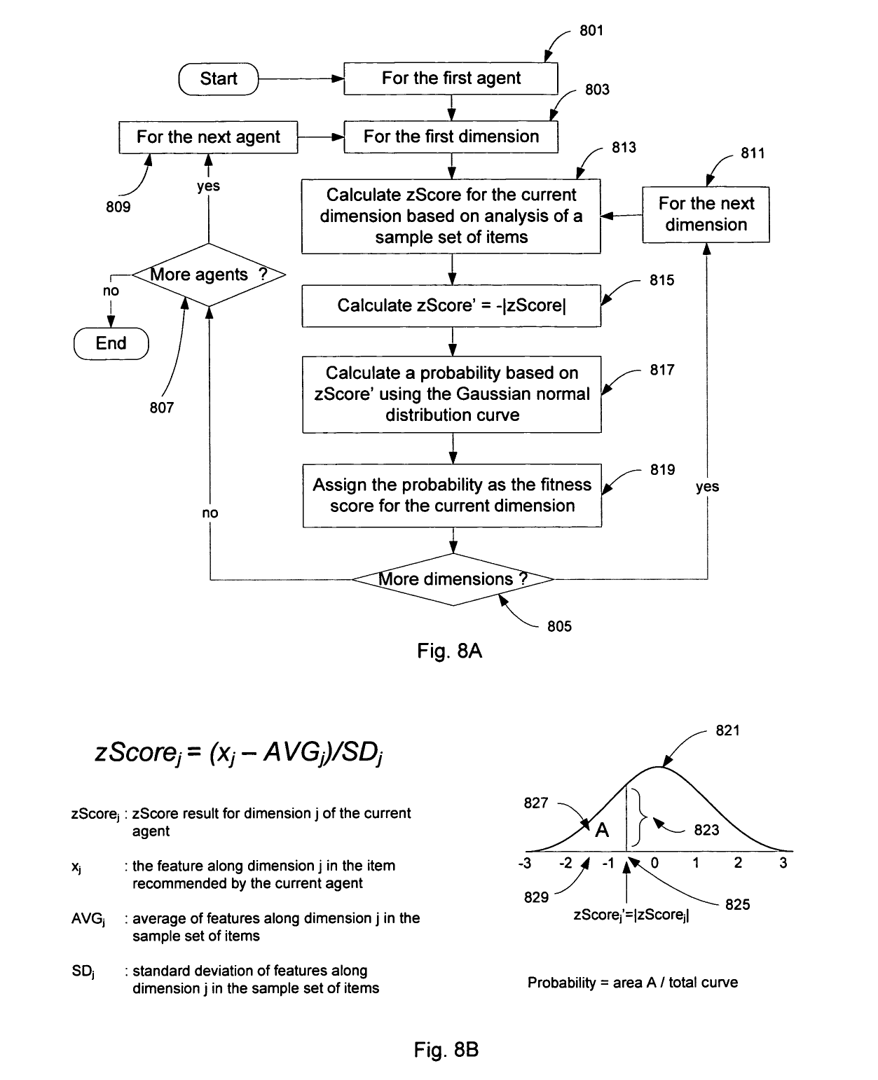

FIG. 8A is a flow diagram illustrating one embodiment of fitness analysis. In one embodiment, this process corresponds to the process at block 701 in FIG. 7. In one embodiment, the fitness analysis process selects the first agent 801, and the first dimension of that first agent 803. In one embodiment, each agent has the same number of dimensions as each item. In one embodiment, each existing agent has a corresponding recommendation item in the recommended set. A relative scaled zScore value is obtained at block 813 based on the feature value along the corresponding dimension of the recommended item of the current agent and the results of an analysis on the sample set of items. At block 815, a zScore value is transformed into a zScore′ value based on the absolute value of the zScore value. At block 817 the process computes a probability value between 0.0 and 1.0 according to a Gaussian normal distribution curve and the zScore′ value. The probability value is then assigned as the fitness score for the corresponding dimension to the current agent, at block 819. The Gaussian normal distribution curve produces a weighting effect that promotes the use of agents with high fitness scores and aggressively demotes agents with low fitness scores. Each existing agent is therefore adapted with corresponding fitness scores assigned.

At block 805 the process determines whether there are more dimensions remaining for analysis. If so, at block 811 the next dimension is selected, and the process continues to block 813 to calculate the zScore for the current dimension.

If no more dimensions remain for analysis, the process continues to block 807. At block 807, the process determines whether there are any more agents that should be analyzed. If so, at block 809 the next agent is selected. The process then returns to block 803, to select the first dimension of the newly selected agent. If there are no remaining agents for analysis, the process ends.

FIG. 8B illustrates detailed formulation to calculate a zScore value and obtain a probability as a fitness score according to one embodiment of the invention. Note that xⱼ is a raw feature value along dimension j from the recommended item of the agent. While both AVGj and SDj are the average and the standard deviation of the feature values along dimension j from the results of the analysis on the sample set of items. The recommended item with feature value xⱼ may or may not be included in the sample set of items. To calculate a fitness score, in one embodiment, a region is identified by a zScore value on a Gaussian normal distribution curve 821. For example, 825 indicates the location of −|zScoreⱼ| value along the horizontal axis 829. A region A 827 is then defined by the enclosure of vertical line at location 825, the Gaussian normal distribution curve, and the horizontal axis 829. A probability is then calculated as the ratio of area size of region A over total region under the Gaussian curve above the horizontal axis.

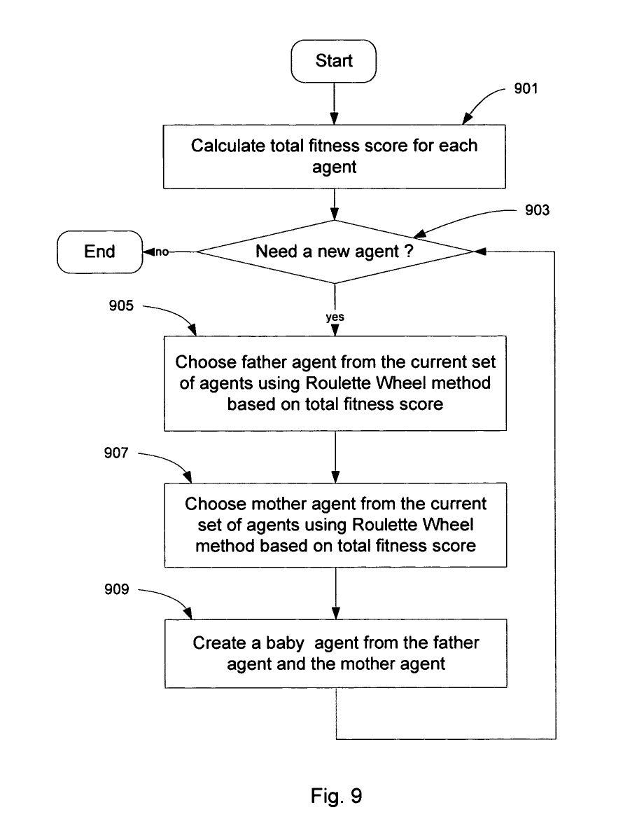

FIG. 9 is a flow diagram illustrating a process to create new agents from existing agents after being adapted with assigned fitness scores according to one embodiment of the invention. The process of block 703 in FIG. 7 may be performed as shown in FIG. 9, in one embodiment. In one embodiment, a total fitness score is calculated for each existing agent 901. In one embodiment, the total fitness score for an agent is calculated by summing up each individual fitness score over all dimensions. The process then determines if there is a need to create any new agent 903. In one embodiment, each search and recommendation cycle requires a predetermined number of agents. If no new agents are needed, the process ends. Otherwise, the process continues to block 905.

To create a new agent, in one embodiment, two different agents are selected from the existing agents as a father agent 905 and a mother agent 907. In one embodiment, the selection is based on a Roulette Wheel method where the complete circle of the wheel corresponds to the sum of the total fitness score for each existing agent. Each agent is allocated a share of the circle proportionate to its total fitness score. Therefore, those agents with higher total fitness scores will have greater probability of being selected when spinning the wheel for agent selection. The father agent and the mother agent will then be combined to create a new baby agent 909. In one embodiment, for example, the father agent, the mother agent and the baby agent have the same number of dimensions, each set of dimensions being a gene. In one embodiment, each gene value in the baby agent is inherited either from the father agent or from the mother agent. The process then returns to block 903 to determine whether a new agent is still needed.

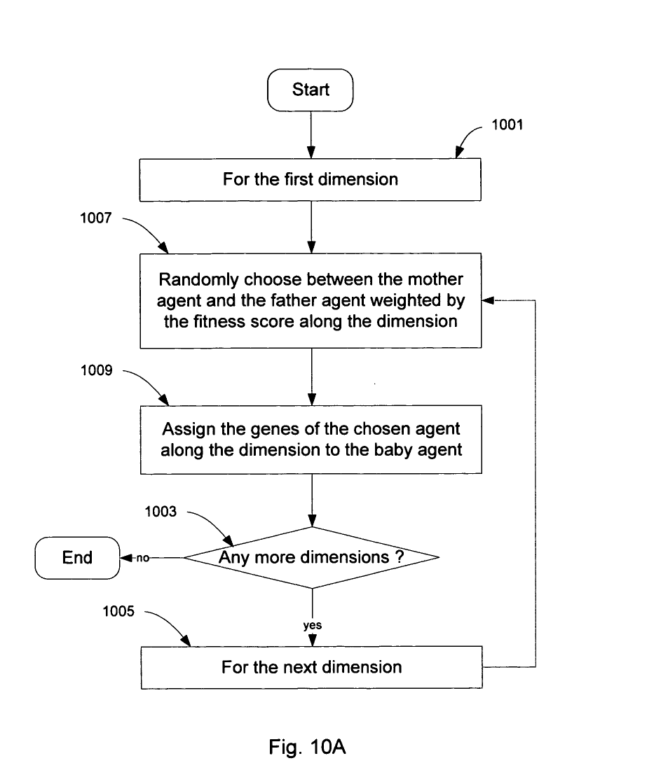

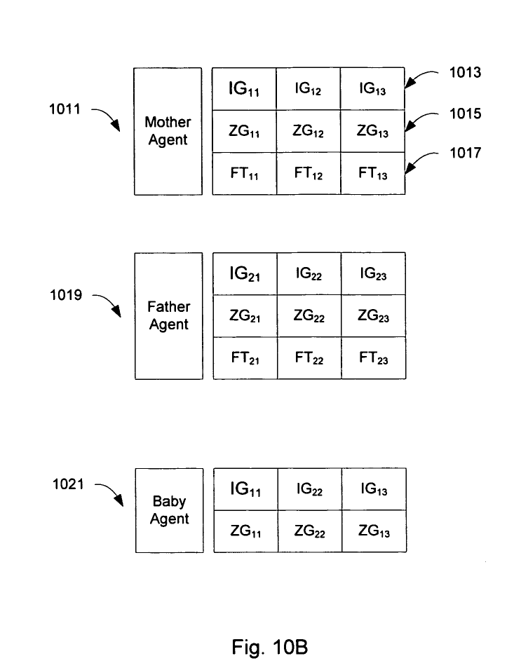

FIG. 10A is a flow diagram illustrating a mating process to create a baby agent by combining a mother agent and a father agent according to one embodiment of the invention. In one embodiment, the process described at block 909 in FIG. 9 may be performed as shown in FIG. 10. In one embodiment, the gene values of the baby agent are assigned along each dimension. The process elects a first dimension at block 1001. Moving along the dimensions, a selection may be made between the mother agent and the father agent 1007. In one embodiment, the selection may be weighted by the fitness scores from the mother agent and the father agent along the current dimension. In one embodiment, the selection between the mother agent with fitness score f₁ and the father agent with fitness score f₂ may be performed according to a random number 0<r<1 and another number F(f₁,f₂) as:

$$F ( {f}_{1} , {f}_{2} ) = \frac{{f}_{1}}{( {f}_{1} + {f}_{2} )}$$

If r>F(f₁,f₂), the father agent is selected. Otherwise, the mother agent is chosen. The corresponding genes of the chosen agent along the same dimension may then be assigned to the baby agent 1009. In one embodiment, the genes include an importance gene and a z-score gene.

At block 1003, the process determines whether there are any more dimensions remaining for analysis. If so, the process selects the next dimension 1005 and returns to block 1007 to make another random selection between the mother agent and the father agent.

FIG. 10B shows an exemplary embodiment of the mating process described in FIG. 10A. Two agents, a mother agent 1011 and a father agent 1019 have been selected to create a baby agent 1021. Each agent is identically structured with three dimensions of gene values. For example, the mother agent 1011 has three importance gene values 1013, and a corresponding three z-score gene values 1015 and fitness scores 1017. The baby agent is created by assigning the gene values for each dimension from either the mother agent or the father agent. In this example, the baby agent inherits from the mother agent gene values for the first and third dimensions and from the father agent for the second dimension. Deciding which agent to inherit gene values from may be performed separately for each dimension according to the fitness scores of the corresponding dimension.

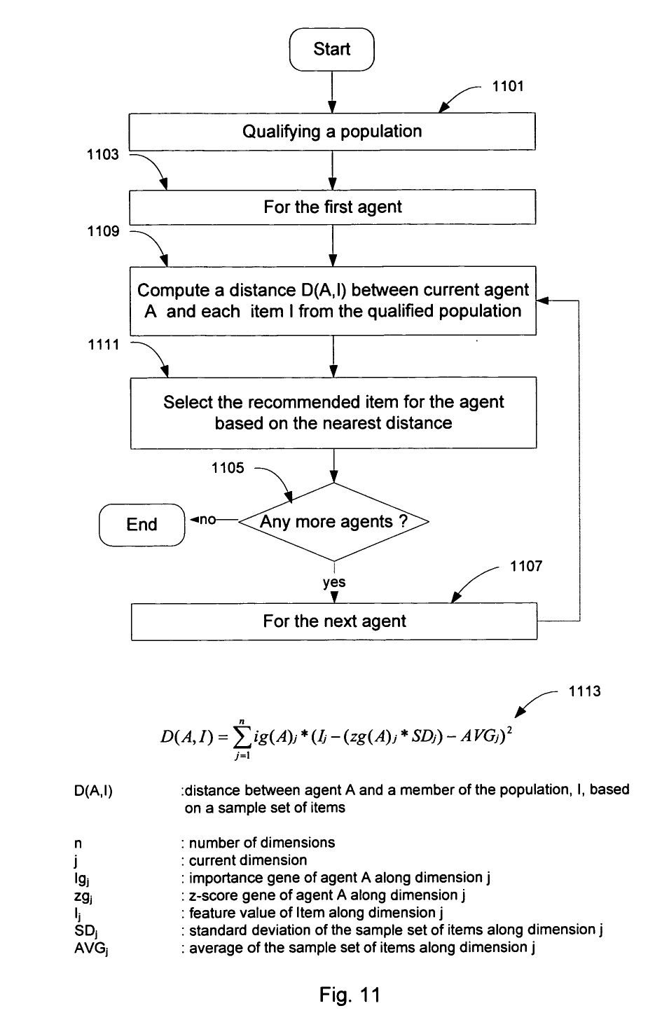

FIG. 11 is a flow diagram illustrating a recommending process by a set of agents to determine recommendations from the population of items according to one embodiment of the invention. In one embodiment, block 107 of FIG. 1 may be performed by the recommending process shown in FIG. 11. In one embodiment, the process starts by qualifying the population by excluding items not qualified as potential recommendations in the current search and recommendation cycle 1101. In one embodiment, those items which have been recommended in the prior search and recommendation cycles are excluded. In one embodiment, each item in the sample set is also excluded. The qualified population may include all the remaining items.

Starting at block 1103, the recommendation process determines for each agent the item most similar to the agent from the qualified population of items as its corresponding recommendation. In one embodiment, the similarity is based on a distance measurement. In one embodiment, at block 1109, a distance between an agent A and an item I is measured as D(A,I). A recommendation by agent A is then selected at block 1111 as the item which is most similar to agent A, for example, with the minimum value of associated distance measure D(A,I). In one embodiment, an example of the distance measurement 1113 is based on gene values along each dimension inside an agent, and the feature value of each dimension of an item.

At block 1105, the recommendation process determines if there are any remaining agents that have not yet been utilized for finding a recommendation. If so, the process selects the next agent 1107, and returns to block 1109 to compute a distance between the current agent and each item. If all of the agents have been used, the process ends.

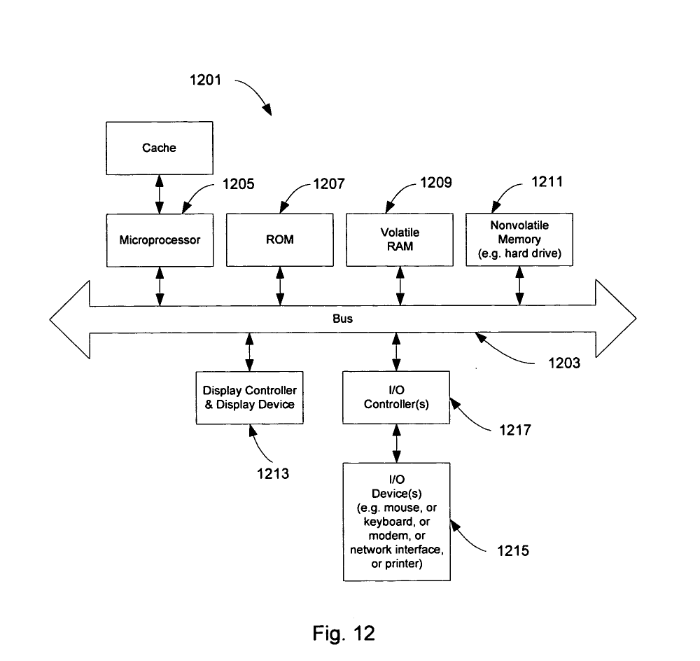

FIG. 12 shows one example of a typical computer system which may be used with the present invention. Note that while FIG. 12 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 12, the computer system 1201, which is a form of a data processing system, includes a bus 1203 which is coupled to a microprocessor(s) 1205 and a ROM (Read Only Memory) 1207 and volatile RAM 1209 and a non-volatile memory 1211. The microprocessor 1203 may retrieve the instructions from the memories 1207 1209 1211 and execute the instructions to perform operations described above. The bus 1203 interconnects these various components together and also interconnects these components 1205, 1207, 1209, and 1211 to a display controller and display device 1213 and to peripheral devices such as input/output (I/O) devices which may be mice, keyboards, modems, network interfaces, printers and other devices which are well known in the art. Typically, the input/output devices 1215 are coupled to the system through input/output controllers 1217. The volatile RAM (Random Access Memory) 1209 is typically implemented as dynamic RAM (DRAM) which requires power continually in order to refresh or maintain the data in the memory.

The mass storage 1211 is typically a magnetic hard drive or a magnetic optical drive or an optical drive or a DVD RAM or other types of memory systems which maintain data (e.g. large amounts of data) even after power is removed from the system. Typically, the mass storage 1211 will also be a random access memory although this is not required. While FIG. 12 shows that the mass storage 1211 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 1203 may include one or more buses connected to each other through various bridges, controllers and/or adapters as is well known in the art.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description above. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A machine implemented method, comprising:
analyzing a plurality of items from a population of items;
adapting a plurality of agents based on the analysis;
creating a new agent from a subset of the plurality of agents; and
selecting an item from the population based on the new agent.

2. The method of claim 1, wherein selecting the item comprises:
measuring a distance between the new agent and the item.

3. The method of claim 1, wherein each item of the population has features with feature values.

4. The method of claim 3, wherein the analyzing comprises:
generating normalized features of the plurality of items based on standard distribution of the feature values.

5. The method of claim 4, further comprising:
creating a start agent, wherein the start agent includes a plurality of the normalized features.

6. The method of claim 1, wherein the adapting comprises:
measuring a fitness relationship between the plurality of items and each of the plurality of agents based on the analysis; and
assigning a fitness value to each of the plurality of agents according to the fitness relationship.

7. The method of claim 6, wherein the fitness relationship is based on a standard distribution of feature values and wherein the fitness value is a probability value.

8. The method of claim 6, wherein the adapting further comprises:
identifying a recommended item for each agent from the population, wherein the fitness relationship is based on the recommended item.

9. The method of claim 1, wherein the creating comprises:
selecting a first agent from the plurality of agents, the first agent having a first gene;
selecting a second agent from the plurality of agents, the second agent having a second gene; and
wherein the new agent includes values from the first gene and values from the second gene.

10. The method of claim 9, wherein selecting the first agent is based on a probability value.

11. The method of claim 9, wherein the first agent has the first gene value along a first dimension, wherein the first agent has a first fitness value along the first dimension, and wherein the second agent has a second fitness value along the first dimension, further comprising:
selecting the first gene value from the first agent and the second agent according to a probability based on the first fitness value and the second fitness value.

12. A machine-readable medium having instructions, when executed by a machine, cause the machine to perform a method, the method comprising:
analyzing a plurality of items from a population of items;
adapting a plurality of agents based on the analysis;
creating a new agent from a subset of the plurality of agents; and
selecting an item from the population based on the new agent.

13. The machine-readable medium of claim 12, wherein selecting the item comprises:
measuring a distance between the new agent and the item.

14. The machine-readable medium of claim 12, wherein each item of the population has features with feature values.

15. The machine-readable medium of claim 14, wherein the analyzing comprises:
generating normalized features of the plurality of items based on standard distribution of the feature values.

16. The machine-readable medium of claim 15, further comprising:
creating a start agent, wherein the start agent includes a plurality of the normalized features.

17. The machine-readable medium having claim 12, wherein the adapting comprises:
measuring a fitness relationship between the plurality of items and each of the plurality of agents based on the analysis; and
assigning a fitness value to each of the plurality of agents according to the fitness relationship.

18. The machine-readable medium of claim 17, wherein the fitness relationship is based on a standard distribution of feature values and wherein the fitness value is a probability value.

19. The machine-readable medium of claim 17, wherein the adapting further comprises:
identifying a recommended item for each agent from the population,
wherein the fitness relationship is based on the recommended item.

20. The machine-readable medium of claim 12, wherein the creating comprises:
selecting a first agent from the plurality of agents, the first agent having a first gene;
selecting a second agent from the plurality of agents, the second agent having a second gene; and
wherein the new agent includes values from the first gene and values from the second gene.

21. The machine-readable medium of claim 20, wherein selecting the first agent is based on a probability value.

22. The machine-readable medium of claim 20, wherein the first agent has the first gene value along a first dimension, wherein the first agent has a first fitness value along the first dimension, and wherein the second agent has a second fitness value along the first dimension, further comprising:
selecting the first gene value from the first agent and the second agent according to a probability based on the first fitness value and the second fitness value.

23. An apparatus, comprising:
an analysis unit to analyze a plurality of items from a population of items;
an adaptation unit to adapt a plurality of agents based on analysis results from the analysis unit;
a creation unit to create a new agent from a subset of the plurality of agents; and
a matching unit to select an item from the population based on the new agent.

24. The apparatus of claim 23, wherein the matching unit comprises:
a measuring unit to measure a distance between the new agent and the item.

25. The apparatus of claim 23, wherein each item of the population has features with feature values.

26. The apparatus of claim 25, wherein the analysis unit comprises:
means for generating normalized features of the plurality of items based on standard distribution of the feature values.

27. The apparatus of claim 26, further comprising:
means for creating a start agent, wherein the start agent includes a plurality of the normalized features.

28. The apparatus of claim 23, wherein the adaptation unit comprises:
means for measuring a fitness relationship between the plurality of items and each of the plurality of agents based on the analysis results; and
means for assigning a fitness value to each of the plurality of agents according to the fitness relationship.

29. The apparatus of claim 28, wherein the fitness relationship is based on a standard distribution of feature values and wherein the fitness value is a probability value.

30. The apparatus of 28, wherein the adaptation unit further comprises:
means for identifying a recommended item for each agent from the population,
wherein the fitness relationship is based on the recommended item.

31. The apparatus of claim 30, further comprising an interface unit, wherein the interface unit presents the recommended item to a client, and wherein the interface unit receives a selected item from the client.

32. The apparatus of claim 23, wherein the creation unit comprises:
means for selecting a first agent from the plurality of agents, the first agent having a first gene;
means for selecting a second agent from the plurality of agents, the second agent having a second gene; and
wherein the new agent includes values from the first gene and values from the second gene.

33. The apparatus of claim 32, wherein the means for selecting the first agent is based on a probability value.

34. The apparatus of 32, wherein the first agent has the first gene value along a first dimension, wherein the first agent has a first fitness value along the first dimension wherein the second agent has a second fitness value along the first dimension, and wherein the creation unit further comprises:
means for selecting the first gene value from the first agent and the second agent according to a probability based on the first fitness value and the second fitness value.

35. An apparatus, comprising:
means for analyzing a plurality of items from a population of items;
means for adapting a plurality of agents based on analysis results from the analyzing;
means for creating a new agent from a subset of the plurality of agents; and
means for selecting an item from the population based on the new agent.
